(19) United States
(12) Patent Application Publication
(10) Pub. No.: US 2008/0028034 A1
(43) Pub. Date: Jan. 31, 2008

(54) METHOD FOR MAPPING AN ISCSI TARGET NAME TO A STORAGE RESOURCE BASED ON AN INITIATOR HARDWARE CLASS IDENTIFIER

(76) Inventors: Andrew Currid, Alameda, CA (US); Mark A. Overby, Bothell, WA (US)

Correspondence Address: PATTERSON & SHERIDAN, L.L.P., 3040 POST OAK BOULEVARD, SUITE 1500, HOUSTON, TX, 77056, US

(21) Appl. No.: 11/459,883

(22) Filed: Jul. 25, 2006

(51) Int. Cl. G06F 15/16

(52) U.S. Cl. 709/217

(57) ABSTRACT

One embodiment of the present invention sets forth a technique for mapping an iSCSI target name to a virtual disk on an iSCSI storage server, based on a hardware class identifier that is included in an iSCSI login request. The hardware class identifier is unique to the particular hardware configuration of the diskless computing device. An iSCSI initiator residing within a diskless computing device includes the hardware class identifier as a vendor-specific parameter in the iSCSI login request to a generic virtual disk. An iSCSI target that resides on the storage server matches the hardware class identifier in the iSCSI login request with a particular virtual disk that contains the boot image for the hardware class of the diskless computing device. In this fashion, an iSCSI initiator-target nexus between the iSCSI initiator and the appropriate virtual disk may be established.

### BACKGROUND OF THE INVENTION

1. Field of the Invention

Embodiments of the present invention relate generally to identifying computer system configurations and more specifically to a method for mapping an iSCSI target name to a storage resource based on an initiator hardware class identifier.

2. Description of the Related Art

In certain computing environments, a storage architecture is deployed in which storage resources on at least one storage server are provided through a data network to one or more client computing devices. One typical type of client computing device is a diskless computing device. The diskless computing device gains access to non-volatile mass storage resources, such as a virtual disk, on the storage sever through a block-level protocol, such as internet small computer system interface (iSCSI).

In an example scenario, a cluster of diskless computing devices communicate with a storage server through an Ethernet network, where each diskless computing device accesses one or more virtual disks on the storage server. In such a scenario, a given diskless computing device is configured to establish an iSCSI login session with the storage server and to request access to a specifically named virtual disk from which the diskless computing device may boot an operating system. The diskless computing device is able to interpret the block and file system structure of the virtual disk, which typically follows the block and file system structure of an otherwise locally attached boot disk, including well-known block numbers that contain the appropriate elements of bootstrap data.

A common problem in such scenarios is that many diskless computing devices with the same hardware configuration may access the same virtual disk on the storage server. Furthermore, the storage server may simultaneously provide multiple diskless computing devices having different hardware configurations access to multiple virtual disks within the storage server since the boot image for each hardware configuration typically resides on a different virtual disk. As previously described, in order to form an appropriate association between an incoming iSCSI login request from a diskless computing device and a suitable virtual disk, stored on the storage server, the diskless computing device is configured to request access to the virtual disk storing the relevant boot image specifically by name. Thus, each diskless computing device is manually configured, typically by system administrative staff, to request a specific virtual disk from a specific storage server. Determining which virtual disk to request also is a manual task that involves matching the particular hardware configuration of the diskless computing device to a known set of virtual disks and their corresponding boot image configuration. The manual steps involved in configuring and managing diskless computing devices is costly, error prone and time consuming.

As the foregoing illustrates, what is needed in the art is a more efficient technique for associating a particular diskless computing device with a corresponding virtual disk on a storage server.

### SUMMARY OF THE INVENTION

One embodiment of the invention sets forth a method for associating a diskless computing device having a certain hardware configuration with a virtual disk that is associated with a known hardware class identifier and contains a boot image tailored for the certain hardware configuration. The method includes the steps of receiving a login request from the diskless computing device, wherein the login request includes a hardware class identifier reflective of the certain hardware configuration, parsing out the hardware class identifier included in the login request, and determining whether the hardware class identifier matches the known hardware class identifier associated with the virtual disk.

One advantage of the disclosed method is that by incorporating a hardware class identifier in the login process, the association between a diskless computing device with a particular hardware configuration and an appropriate virtual disk containing the boot image tailored for that hardware configuration may be established automatically. By employing this method, each diskless computing device, regardless of hardware configuration, can be configured to boot from a server, with no related manual configuration.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a conceptual diagram of a storage client-server system that includes diskless computing devices connected through a network to a storage server, according to one embodiment of the invention; and

FIG. 2 is a flow diagram of method steps for associating a diskless computing device iSCSI login request to a specific virtual disk, according to one embodiment of the invention.

### DETAILED DESCRIPTION

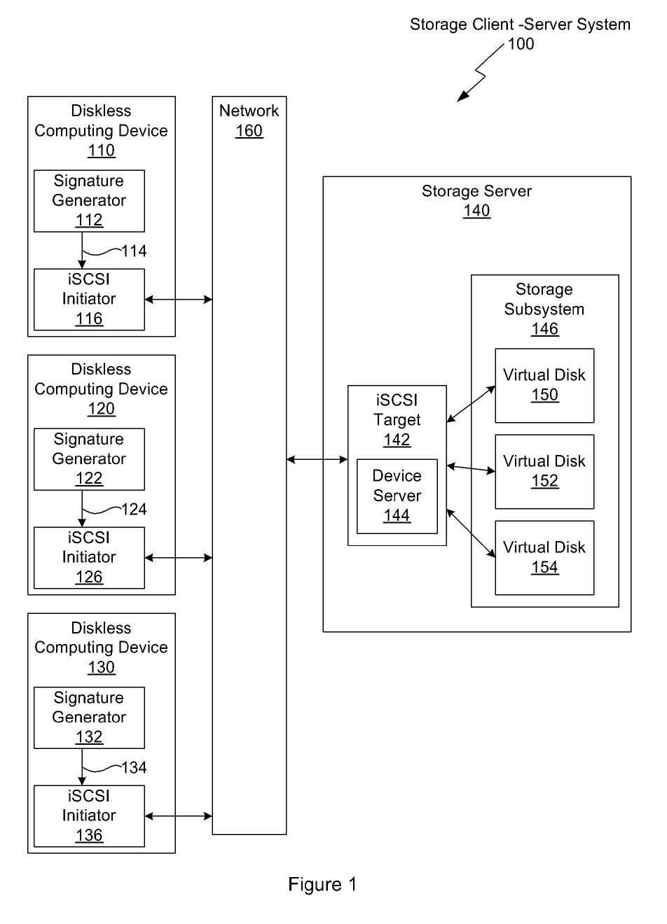

FIG. 1 is a conceptual diagram of a storage client-server system 100 that includes diskless computing devices 110, 120, 130 connected through a network 160 to a storage server 140, according to one embodiment of the invention. As configured, the diskless computing devices 110, 120, 130 act as storage clients of the storage server 140.

Diskless computing device 110 includes, without limitation, a signature generator 112 and an iSCSI initiator 116. The signature generator 112 computes a hardware class identifier 114 (also referred to as a “signature value”) that is unique to the particular hardware configuration of diskless computing device 110. The hardware class identifier 114 has the important characteristic that an operating system boot image suitable to boot one instance of a diskless computing device having a given hardware class identifier will boot any other instance of a diskless computing device having the same hardware class identifier. The signature generator 112 is described in greater detail in the co-pending application entitled “Method to Accelerate Identification of Hardware Platform Classes,” filed on ______, 2006 and having attorney docket number NVDA/P002390.

The iSCSI initiator 116 may behave identically to the well-known behavior of a standard iSCSI initiator, with two additional behaviors. The first additional behavior is that the iSCSI initiator 116 includes the hardware class identifier 114 as a vendor-specific parameter in an iSCSI login request to the storage server 140. The second additional behavior is that the iSCSI initiator 116 transmits iSCSI login requests to a generic virtual disk with a name established to mean a “boot disk” for the purpose of booting the diskless computing device 110.

Diskless computing device 120 is constructed with the same architecture as diskless computing device 110 and includes a signature generator 122, which computes a hardware class identifier 124, and an iSCSI initiator 126 that operates identically to iSCSI initiator 116. Diskless computing device 130 also is constructed with the same architecture as diskless computing device 110 and includes a signature generator 132, which computes a hardware class identifier 134, and an iSCSI initiator 136 that operates identically to iSCSI initiator 116.

Network 160 implements a data network using any technically feasible technique. For example, network 160 may include, without limitation, hubs, switches or routers, or any combination thereof. Ethernet is an example protocol that may be used to transport iSCSI traffic over the network 160.

Storage server 140 includes storage subsystem 146 and at least one instance of an iSCSI target 142. The storage subsystem 146 implements a mass storage system using any feasible mass storage technology and presents a set of virtual disks 150, 152, 154 to the iSCSI target 142. In one embodiment, the iSCSI target 142 is a software module that executes on the storage server 140 and implements the well-known behaviors associated with an iSCSI target. In alternate embodiments, the iSCSI target 142 and the device server 144 may be implemented directly in hardware or as microcode executing on specialized hardware. The iSCSI target 142 includes a device server 144 configured to map iSCSI requests that name the generic virtual disk to a specifically selected virtual disk, as established during the iSCSI login by the hardware class identifiers included in the iSCSI login requests. This mapping forms the basis for an initiator-target ( ) nexus that is established between a given iSCSI initiator and a given virtual disk.

For example, suppose diskless computing devices 110 and 120 have identical hardware configurations and therefore share an identical hardware class identifier that maps to virtual disk 150. At some point in the boot chronology of diskless computing device 110, signature generator 112 computes a hardware class identifier 114 that is included in an iSCSI login request generated by the iSCSI initiator 116. This iSCSI login request names a generic virtual disk as the iSCSI login target. Importantly, iSCSI target 142 is configured to remap this request to the virtual disk in storage server 140 that contains the appropriate boot image for diskless computing device 110 using the hardware class identifier 114. More specifically, the iSCSI target 142 parses out the hardware class identifier 114 that is included in the iSCSI login request. This hardware class identifier 114 is then compared to a list of known hardware class identifiers, where each known hardware class identifier is paired with a specific virtual disk on storage server 140 that contains the boot image for the diskless computing device hardware class represented by the hardware class identifier. If a match is not found, then an error is reported. If a match is found, then the class identifier 114 is associated with the appropriate virtual disk, here, virtual disk 150. The iSCSI target 142 is further configured to associated the iSCSI login request from iSCSI initiator 116 with virtual disk 150. The device server 144 records the association and maps future requests from the iSCSI initiator 116 to the virtual disk 150.

Since diskless computing device 120 has a hardware class identifier 124 equal to the hardware class identifier 114, the iSCSI login process for diskless computing device 120 follows the iSCSI login process for diskless computing device 110. In both cases the iSCSI initiators 116 and 126 request an iSCSI login to a generic virtual disk. In both cases, the iSCSI login request to the generic virtual disk results in an initiator-target nexus involving the virtual disk 150.

Suppose further that the hardware class identifier 134 of diskless computing device 130 has a value associated with virtual disk 152 and is thus different from hardware class identifiers 114 and 124. The iSCSI login process for diskless computing device 130 generally follows the iSCSI login process for diskless computing device 110. However, the resulting initiator-target nexus involves virtual disk 152 as opposed to virtual disk 150. In this example, virtual disk 154 has no corresponding diskless computing device. However, a diskless computing device may be added to the storage client-server system 100 that utilizes virtual disk 154.

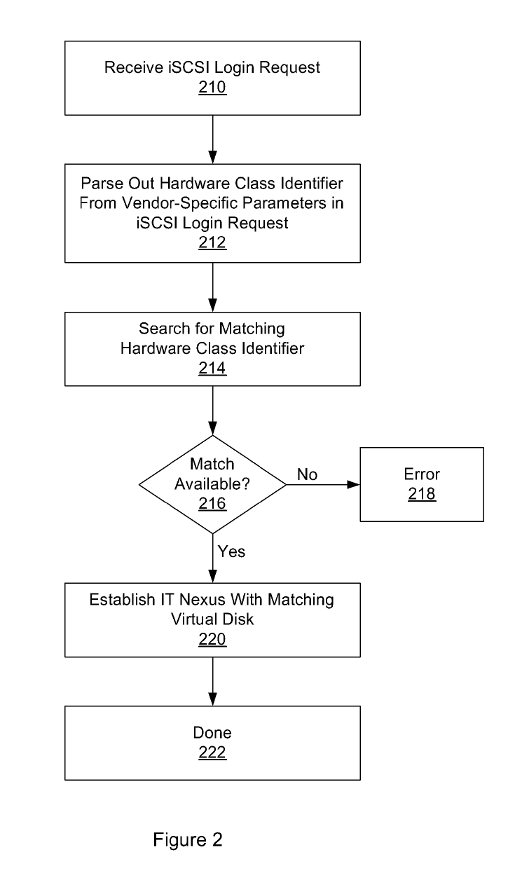

FIG. 2 is a flow diagram of method steps for associating a diskless computing device iSCSI login request to a specific virtual disk, according to one embodiment of the invention. Although the method steps are described in conjunction with FIG. 1, persons skilled in the art will understand that any system that performs the method steps, in any order, is within the scope of the invention.

The method for associating a diskless computing device with a specific virtual disk begins in step 210, where an iSCSI target 142 residing within the storage server 140 receives an iSCSI login request from an iSCSI initiator residing in a diskless computing device that is a client of the storage server 140. As previously described herein, the iSCSI login request includes a hardware class identifier that uniquely identifies the hardware platform of the diskless computing device. In step 212, the iSCSI target 142 parses out the hardware class identifier from the vendor specific parameters included in the iSCSI login request. In step 214, the iSCSI target 142 attempts to match the hardware class identifier with a known set of hardware class identifiers. In step 216, if no match is available then the storage server 140 does not have a virtual disk residing in the storage subsystem 146 that contains the appropriate boot image for the diskless computing device, and the method terminates in step 218, where an error is reported.

If, in step 216, a matching hardware class identifier is found, then the method proceeds to step 220, where the iSCSI target 142 establishes an initiator-target nexus between the iSCSI initiator and the virtual disk paired with the hardware class identifier. This virtual disk contains the appropriate boot image for the diskless computing device. The method then terminates in step 222.

In sum, by incorporating a hardware class identifier in the iSCSI login process, the association between a diskless computing device with a particular hardware configuration and an appropriate virtual disk containing the boot image tailored for that hardware configuration may be established automatically. As described herein, the diskless computing device generates the hardware class identifier, based on an autonomous, internal hardware discovery process. This hardware class identifier is included as a vendor-specific parameter in an iSCSI login request to the storage server, with a generic boot disk named as the iSCSI login target. The iSCSI target residing in the storage server uses the hardware class identifier to map the iSCSI login request to a virtual disk that contains the boot image that is appropriate for the specific hardware class of the client diskless computing device. Thus, each diskless computing device, regardless of hardware configuration, is capable of booting from a server, with no related manual configuration.

While the forgoing is directed to embodiments of the present invention, other and further embodiments of the invention may be devised without departing from the basic scope thereof, and the scope thereof is determined by the claims that follow.

We claim:

1. A method for associating a diskless computing device having a certain hardware configuration with a virtual disk that is associated with a known hardware class identifier and contains a boot image tailored for the certain hardware configuration, the method comprising:
receiving a login request from the diskless computing device, wherein the login request includes a hardware class identifier reflective of the certain hardware configuration;
parsing out the hardware class identifier included in the login request; and
determining whether the hardware class identifier matches the known hardware class identifier associated with the virtual disk.

2. The method of claim 1, wherein the hardware class identifier does not match the known hardware identifier, and further comprising the step of reporting an error.

3. The method of claim 1, wherein the hardware class identifier matches the known hardware identifier, and further comprising the step of establishing an initiator-target nexus between the diskless computing device and the virtual disk.

4. The method of claim 1, wherein the login request is an internet small computer system interface (iSCSI) login request generated by an iSCSI initiator resident on the diskless computing device.

5. The method of claim 1, wherein the hardware class identifier is generated by a signature generator resident on the diskless computing device.

6. The method of claim 1, wherein the virtual disk is resident in a storage subsystem of a storage server.

7. The method of claim 6, wherein the login request is a login to a generic virtual disk resident on the storage server.

8. A computer-readable medium including instructions that when executed cause a computing device to associate a diskless computing device having a certain hardware configuration with a virtual disk that is associated with a known hardware class identifier and contains a boot image tailored for the certain hardware configuration, by performing the steps of:
receiving a login request from the diskless computing device, wherein the login request is a login includes a hardware class identifier reflective of the certain hardware configuration;
parsing out the hardware class identifier included in the login request; and
determining whether the hardware class identifier matches the known hardware class identifier associated with the virtual disk.

9. The computer-readable medium of claim 8, wherein the hardware class identifier does not match the known hardware identifier, and further comprising the step of reporting an error.

10. The computer-readable medium of claim 8, wherein the hardware class identifier matches the known hardware identifier, and further comprising the step of establishing an initiator-target nexus between the diskless computing device and the virtual disk.

11. The computer-readable medium of claim 8, wherein the login request is an internet small computer system interface (iSCSI) login request generated by an iSCSI initiator resident on the diskless computing device.

12. The computer-readable medium of claim 8, wherein the hardware class identifier is generated by a signature generator resident on the diskless computing device.

13. The computer-readable medium of claim 8, wherein the computing device is a storage server and the virtual disk is resident in a storage subsystem of the storage server.

14. The computer-readable medium of claim 13, wherein the login request is a login to a generic virtual disk resident on the storage server.

15. A computing system comprising:
a diskless computing device having a certain hardware configuration and including:
a signature generator configured to generate a hardware class identifier reflective of the certain hardware configuration, and
an internet small computer system interface (iSCSI) initiator configured to transmit an iSCSI login request that includes the hardware class identifier; and
a storage device having:
a storage subsystem that includes a virtual disk that is associated with a known hardware class identifier and contains a boot image tailored for the certain hardware configuration of the diskless computing device, and
an iSCSI target configured to:
receive the iSCSI login request from the diskless computing device,
parse out the hardware class identifier included in the iSCSI login request, and
determine whether the hardware class identifier matches the known hardware class identifier.

16. The computing system of claim 15, wherein the iSCSI login request transmitted by the diskless computing device is a login to a generic virtual disk residing on the storage device.

17. The computing system of claim 15, wherein the hardware class identifier does not match the known hardware identifier, and the iSCSI target is further configured to report an error.

18. The computing system of claim 15, wherein the hardware class identifier matches the known hardware class identifier, and the iSCSI target is further configured to establish an initiator-target nexus between the diskless computing device and the virtual disk.
